(19) United States
(12) Patent Application Publication
(10) Pub. No.: US 2016/0077784 A1
(43) Pub. Date: Mar. 17, 2016

(54) READING DEVICE

(71) Applicant: Panasonic Intellectual Property Management Co., Ltd., Osaka (JP)

(72) Inventor: Kazuhiro YAMADA, Osaka (JP)

(21) Appl. No.: 14/852,718

(22) Filed: Sep. 14, 2015

(30) Foreign Application Priority Data
Sep. 16, 2014 (JP) 2014-187373
Mar. 13, 2015 (JP) 2015-050937

(51) Int. Cl. G06F 3/147; G06F 3/0354; G06F 3/044; G06F 3/14

(52) U.S. Cl. CPC G06F 3/147; G06F 3/1423; G06F 3/03545; G06F 3/044

(57) ABSTRACT

A reading device is a reading device which can communicate with and connect to one of a plurality of devices which each include a position coordinate pattern representing information related to a position, and includes a communicator which communicates with and connects to a plurality of devices; a memory which stores a plurality of pieces of unique information associated with the plurality of devices, respectively; a pattern obtaining unit which obtains the position coordinate pattern; and a controller which selects one of the plurality of pieces of unique information based on the obtained position coordinate pattern, and controls the communicator to establish wireless connection with a device associated with the selected unique information.

### BACKGROUND

1. Technical Field

The present disclosure relates to a reading device which can configure a display control system together with a plurality of display devices.

2. Description of the Related Art

As disclosed in Unexamined Japanese Patent Publication No. 2012-243201, a technique of reading a position information pattern representing a coordinate position on a plane of a display device by using a pen type reading device is known.

### SUMMARY

A reading device according to the present disclosure is a reading device which can communicate with and connect to one of a plurality of devices which each include a position coordinate pattern representing information related to a position, and includes

a communicator which communicates with and connects to a plurality of devices;

a memory which stores a plurality of pieces of unique information associated with the plurality of devices, respectively;

a pattern obtaining unit which obtains the position coordinate pattern; and

a controller which selects one of the plurality of pieces of unique information based on the obtained position coordinate pattern, and controls the communicator to establish wireless connection with a device associated with the selected unique information.

### BRIEF DESCRIPTION OF DRAWINGS

FIG. 1 is an image view illustrating an external appearance of display control system 100;

FIG. 2 is a block diagram illustrating a configuration of display control system 100;

FIG. 3 is a sectional view of display panel 210;

FIG. 4A is an enlarged image view for explaining a dot pattern;

FIG. 4B is an enlarged image view for explaining a dot pattern;

FIG. 5A is an image view for explaining a position of dot 212 corresponding to a numerical value of “1”;

FIG. 5B is an image view for explaining the position of dot 212 corresponding to a numerical value of “2”;

FIG. 5C is an image view for explaining the position of dot 212 corresponding to a numerical value of “3”;

FIG. 5D is an image view for explaining the position of dot 212 corresponding to a numerical value of “4”;

FIG. 6A is an image view illustrating a displaying operation in a case where a plurality of display devices to be a communication target of a digital pen are close;

FIG. 6B is an image view illustrating a displaying operation in a case where a plurality of display devices to be a communication target of a digital pen are close;

FIG. 7 is a flowchart of an operation of pairing the digital pen and a display device;

FIG. 8 is a flowchart of an operation of reconnecting the digital pen and a display device;

FIG. 9 is a flowchart of a displaying operation;

FIG. 10A is a view for explaining a pixel block pattern according to another exemplary embodiment;

FIG. 10B is a view for explaining a pixel block pattern according to another exemplary embodiment;

FIG. 10C is a view for explaining a pixel block pattern according to another exemplary embodiment;

FIG. 10D is a view for explaining a pixel block pattern according to another exemplary embodiment; and

FIG. 11 is a block diagram illustrating a configuration of a display control system according to a modified example of the first exemplary embodiment of the present disclosure.

### DETAILED DESCRIPTION

Exemplary embodiments will be described below in detail optionally with reference to the drawings. In this regard, the exemplary embodiments will not be described in detail more than necessary. For example, matters which have already been well-known will not be described in detail, and overlapping description of same components will not be made to prevent the following description from becoming redundant more than necessary, and help one of ordinary skill in the art to understand the exemplary embodiments.

In addition, the inventor(s) of the present invention provide the accompanying drawings and the following description to help one of ordinary skill in the art to sufficiently understand the present disclosure, and do not intend to limit the subject matter of the claims.

### First Exemplary Embodiment

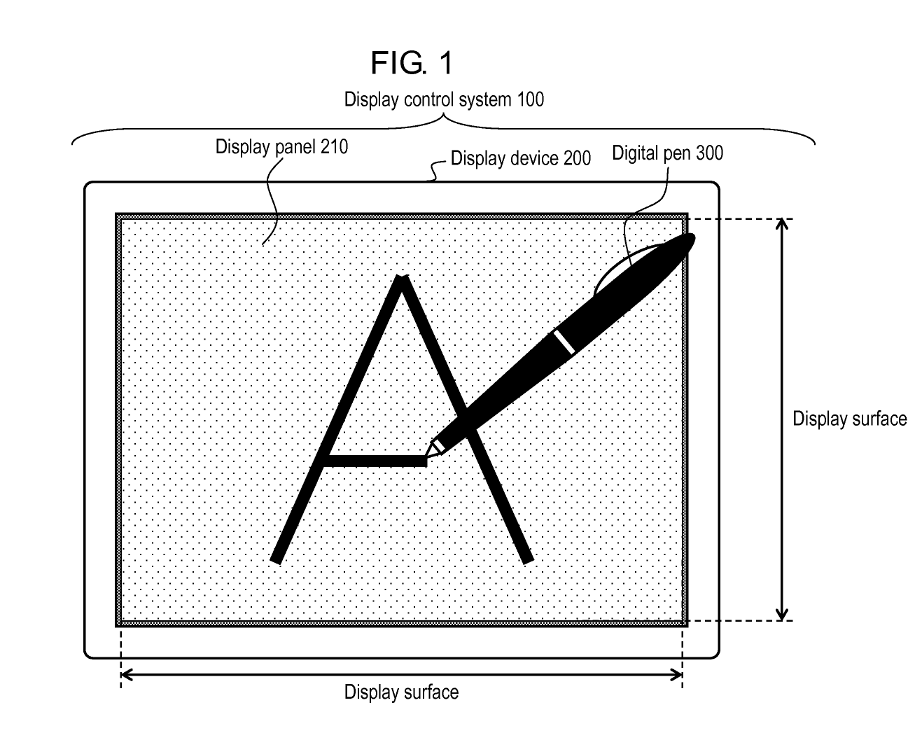

FIG. 1 is an image view illustrating an external appearance of display control system 100 according to the first exemplary embodiment. Display control system 100 includes display device 200 and optical digital pen (referred to simply as a “digital pen” below.) 300. In this regard, as described below, digital pen 300 is a reading device which communicates with and connects to a specific display device of a plurality display devices which each includes a position coordinate pattern (also referred to as a “position information pattern” below) representing information related to a position. Display device 200 includes display panel 210. A display surface which can display images and the like is defined on the surface of display panel 210.

A dot pattern representing information related to a position on display panel 210 is provided on the display surface of display panel 210. By optically reading a dot pattern at a pen point position, digital pen 300 can detect information related to a position on display panel 210 at which a point of digital pen 300 is positioned (such information will be also referred to as “position information” below). Display device 200 nd digital pen 300 perform wireless communication, and digital pen 300 transmits the detected position information to display device 200. Thus, display device 200 can learn position information indicating a pen point position of digital pen 300, and performs various types of control.

For example, a case where the point of digital pen 300 is moved on display panel 210 will be assumed. In this case, digital pen 300 detects continuous pieces of position information as a stroke of the point of digital pen 300 from a continuously read dot pattern. Digital pen 300 successively transmits pieces of detected position information to display device 200. Consequently, display device 200 can continuously display dots on display panel 210 according to the stroke of the point of digital pen 300. By using this function, a user can manually input characters and figures to display panel 210 by digital pen 300.

### [2. Configuration of Display Control System 100]

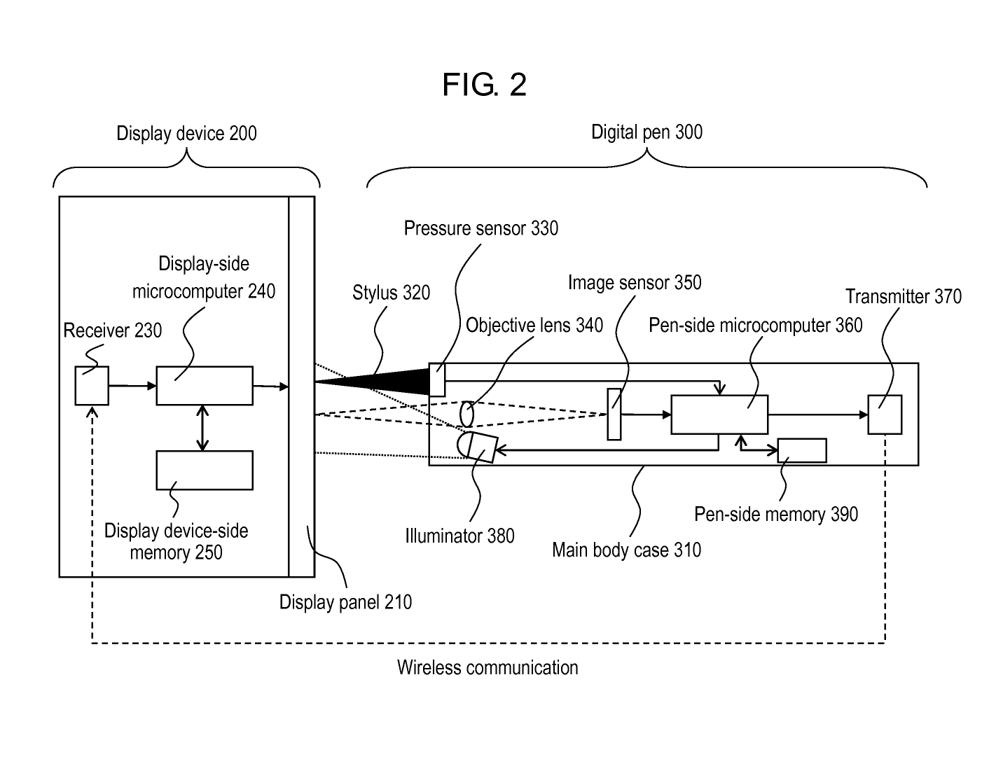

Next, the configuration of display control system 100 will be described. FIG. 2 is a block diagram illustrating the configuration of display control system 100.

Display device 200 includes display panel 210, receiver 230, display-side microcomputer 240 and display device-side memory 250. Display device 200 may include other electric components which will not be described.

The receiver 230 receives signals transmitted from digital pen 300. Receiver 230 is a communication module which includes an electronic circuit which transmits received signals to display-side microcomputer 240.

Display-side microcomputer 240 includes a CPU (Central Processing Unit) (MPU (Micro-Processing Unit)) and a memory. Display-side microcomputer 240 controls contents to be displayed on display panel 210, based on signals transmitted from digital pen 300. Display-side microcomputer 240 may include an electronic circuit (e.g. a FPGA (Field-Programmable Gate Array), an ASIC (Application Specific Integrated Circuit) or a DSU (Digital Service Unit)) which is designed to realize a predetermined function, in addition to a CPU or the like.

Display device-side memory 250 stores a program which causes the CPU of display-side microcomputer 240 to operate. Further, as described below in detail, display device-side memory 250 stores a table which manages MAC (Media Access Control) addresses for authenticating digital pen 300 which is a communication partner. Display-side microcomputer 240 can optionally read and write information to and from display device-side memory 250.

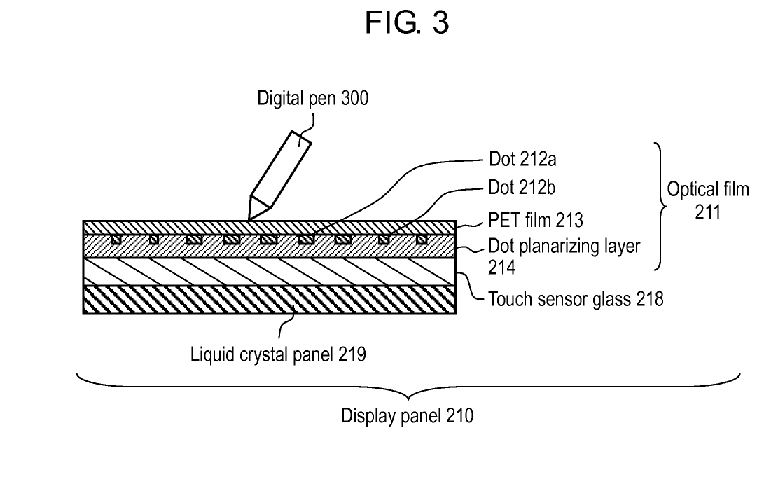

Next, a configuration display panel 210 will be described in detail. FIG. 3 is a sectional view of display panel 210 according to the first exemplary embodiment.

As illustrated in FIG. 3, display panel 210 includes optical film 211, touch sensor glass 218 and liquid crystal panel 219.

Optical film 211 includes PET film 213 which is a base material, dot patterns which include a plurality of dots 212 and dot planarizing layer 214. Hereinafter, this dot pattern will be described in detail. This dot pattern is formed by an optical film manufacturer. That is, the optical film manufacturer forms all dot patterns, and applies a partial dot pattern of an entire dot pattern to optical film 211. PET film 213 protects a surface of display panel 210, and functions as a base material for stacking layers such as dots 212.

A plurality of dots 212 is stacked in a back surface (a lower surface in FIG. 3) of PET film 213. Each dot 212 projects by a thickness of each dot 212 from the back surface of PET film 213. Further, a set of a plurality of dots 212 in unit area 213 described below in detail forms one dot pattern. Each dot 212 is made of a material which absorbs infrared light (a material of a low transmittance with respect to infrared light).

Dot planarizing layer 214 is stacked on the back surface of PET film 213 to fill between a plurality of dots 212. In other words, dot planarizing layer 214 is formed to cover the back surface of PET film 213 and the surfaces of a plurality of dots 212. Dot planarizing layer 214 is formed over the entire back surface of PET film 213. Further, the back surface of dot planarizing layer 214 is a planarized surface. Dot planarizing layer 214 is made of a material which allows visible light and infrared light to transmit. Dot planarizing layer 214 is made of, for example, acrylic resin.

Touch sensor glass 218 is glass which includes a sensor which detects a user's touching operation on display panel 210 by a known technique. Touch sensor glass 218 is arranged on the back surface (the lower surface in FIG. 3) of dot planarizing layer 214.

Liquid crystal panel 219 includes a color filter and a liquid crystal layer. A backlight device (not illustrated) which irradiates liquid crystal panel 219 with light is arranged on the back surface of liquid crystal panel 219. Liquid crystal panel 219 applies a voltage for changing a liquid crystal molecular orientation of a liquid crystal layer based on display control of display-side microcomputer 240. Then, liquid crystal panel 219 controls a transmittance amount of light from the backlight device, and executes various displaying operations.

Next, a detailed configuration of digital pen 300 will be described with reference to FIG. 2.

Digital pen 300 includes cylindrical main body case 310, and stylus 320 attached to a point of main body case 310. Further, digital pen 300 includes, in main body case 310, pressure sensor 330, objective lens 340, image sensor 350, pen-side microcomputer (controller) 360, pen-side memory 390, transmitter 370 and illuminator 380.

Main body case 310 is formed in an external shape similar to a shape of a general pen, and is formed in a cylindrical shape. Stylus 320 is formed in a cylindrical or a tapered shape. A tip of stylus 320 is rounded to such a degree that the surface of display panel 210 is not damaged. In addition, a shape of stylus 320 is preferably formed in a shape which allows a user to easily recognize an image displayed on display panel 210.

Pressure sensor 330 is built in main body case 310, and is jointed to a base end of stylus 320. Pressure sensor 330 detects a pressure which is applied to tip of stylus 320, and transmits this detection result to pen-side microcomputer 360. More specifically, pressure sensor 330 detects a pressure which is applied from display panel 210 to tip of stylus 320 when the user writes characters on display panel 210 by using digital pen 300. Pressure sensor 330 is used to determine whether or not the user intends to make an input by using digital pen 300. When, for example, pressure sensor 330 detects a predetermined pressure or more, it is determined that the user intends to make an input.

Illuminator 380 is provided at a front end of main body case 310 and near stylus 320. Illuminator 380 is formed as, for example, an infrared LED (Light Emitting Diode). Illuminator 380 is configured to, when it is determined based on a detection result of pressure sensor 330 that the user intends to make an input, emit infrared light from the front of main body case 310.

Objective lens 340 forms an image of light incident from the tip of stylus side, on image sensor 350. Objective lens 340 is provided at a front end of main body case 310 and near tip of stylus 320. When infrared light is emitted from illuminator 380 in a state where the tip of digital pen 300 is directed toward the display surface of display device 200, the infrared light transmits through display panel 210 and is diffused and reflected by liquid crystal panel 219 positioned at a back side of display panel 210. As a result, part of infrared light having transmitted through display panel 210 returns to a digital pen 300 side. Objective lens 340 receives an input of infrared light emitted from illuminator 380 and diffused and reflected from display device 200. Image sensor 350 is provided on an optical axis of objective lens 340. Hence, infrared light having transmitted through objective lens 340 is formed on an imaging plane of image sensor 350.

Image sensor 350 outputs an image signal obtained by converting an optical image formed on the image plane into an electrical signal, to pen-side microcomputer 360. Image sensor 350 is configured as, for example, a CCD (Charge-Coupled Device) image sensor or a CMOS (Complementary Metal-Oxide Sensor) image sensor. Although described in detail below, each dot 212 which makes up a dot pattern is made of a material which absorbs infrared light (a material having a comparatively low transmittance with respect to infrared light). Hence, each dot 212 which makes up a dot pattern is made of a material which absorbs infrared light (a material having a high transmittance with respect to infrared light). Thus, little infrared light returns to digital pen 300 from an internal region of dot 212. On the other hand, more infrared light returns from external region of dot 212 than from regions of dots 212. As a result, an optical image represented as a black dot pattern is captured by image sensor 350.

Pen-side microcomputer 360 (an example of the controller) specifies information of a position of digital pen 300 on display panel 210 based on an image signal captured and generated by image sensor 350. More specifically, pen-side microcomputer 360 obtains a pattern shape of the dot pattern from the image signal captured and generated by image sensor 350 which functions as a pattern obtaining unit, and specifies the position of tip of stylus 320 on display panel 210 based on this pattern shape. Pen-side microcomputer 360 includes a CPU or a MPU. Pen-side microcomputer 360 may include an electronic circuit (e.g. a FPGA, an ASIC or a DSU) which is designed to realize a predetermined function, in addition to a CPU or a MPU.

Pen-side memory 390 stores a program which causes the CPU of pen-side microcomputer 360 to operate. Further, as described below in detail, pen-side memory 390 functions as a memory and stores a table which manages MAC addresses associated with display devices 200 which are communication partners. Pen-side microcomputer 360 optionally reads and writes information from and in pen-side memory 390.

Transmitter 370 (an example of a communicator) is a communication module which includes an electronic circuit which transmits signals to an outside and communicates with and connects to a device. More specifically, transmitter 370 transmits position information specified by pen-side microcomputer 360 to receiver 230 of display device 200 which is a wireless communication partner.

### [3. Details of Dot Pattern]

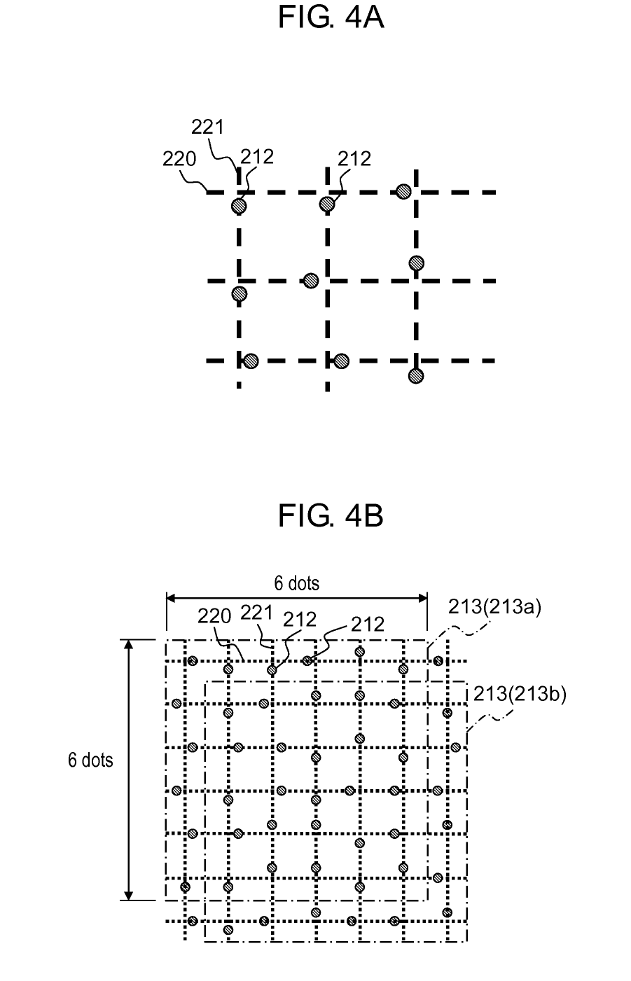

The dot pattern will be described in detail below. FIG. 4A is an enlarged view when optical film 211 is seen from the front. FIG. 4B is a view when optical film 211 is seen from the front. FIGS. 4A and 4B illustrate first reference lines 220 and second reference lines 221 as virtual lines (lines which do not actually exist on optical film 211) on optical film 211, in order to explain positions of dots 212 of the dot pattern. First reference lines 220 and second reference lines 221 are orthogonal to each other. In FIGS. 4A and 4B, grids are formed by a plurality of first reference lines 220 and a plurality of second reference lines 221.

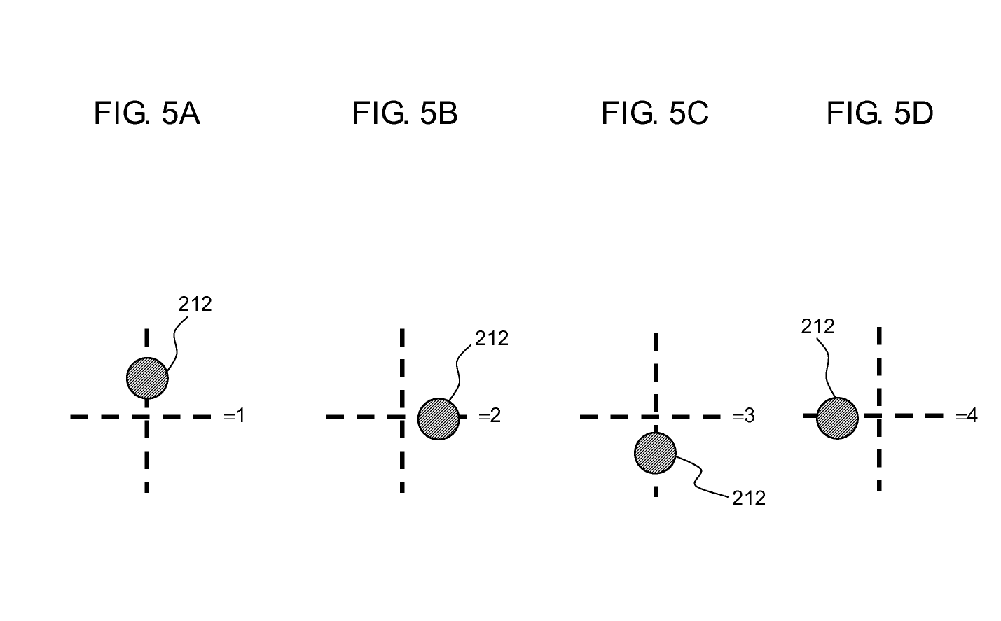

Each dot 212 is arranged around an intersection of first reference line 220 and second reference line 221. That is, each dot 212 is arranged near each grid point. FIGS. 5A and 5B are views illustrating arrangement patterns of dot 212. When an extension direction of first reference line 220 is an X direction and an extension direction of second reference line 221 is a Y direction, each dot 212 is arranged at a position offset (shifted) from an intersection of first reference line 220 and second reference line 221 toward a plus side or a minus side along the X direction or the Y direction. More specifically, dot 212 is provided on optical film 211 in one of arrangements in FIGS. 5A to 5D. According to the arrangement in FIG. 5A, dot 212 is arranged at a position on an upper side of the intersection of first reference line 220 and second reference line 221. This arrangement corresponds to a value “1”. According to the arrangement in FIG. 5B, dot 212 is arranged at a position on a right side of the intersection of first reference line 220 and second reference line 221. This arrangement corresponds to a value “2”. According to the arrangement in FIG. 5C, dot 212 is arranged at a position on a lower side of the intersection of first reference line 220 and second reference line 221. This arrangement corresponds to a value “3”. According to the arrangement in FIG. 5D, dot 212 is arranged at a position on a left side of the intersection of first reference line 220 and second reference line 221. This arrangement corresponds to a value “4”. As described above, each dot 212 is read as one of numerical values of “1” to “4” by digital pen 300 according to each arrangement pattern.

Further, as illustrated in FIG. 4B, one unit area 213 includes 6 dots×6 dots, and 36 dots 212 included in unit area 213 forms one dot pattern. Each of 36 dots 212 included in unit area 13 is provided in one of the arrangements corresponding to one of the numerical values of “1” to “4” illustrated in FIGS. 5A to 5D. Consequently, it is possible to define an enormous number of (in a case where one unit area includes 6 dots×6 dots, 36 squares-of-4) dot patterns having different pieces of information.

In this regard, optical films on which an enormous number of dot patterns having different pieces of information from each other as described is formed are manufactured by an optical film manufacturer. Each device manufacturer purchases part of these optical films from the optical film manufacturer. Further, each device manufacturer further divides part of the purchased optical film, and manufactures devices (e.g. display devices 200) by using the divided films. Depending on dot intervals, it is possible to define as a dot pattern the coordinates of a vast plane having, for example, an area of 60 million square kilometers (nearly corresponding to an area of the Eurasian continent). Dot patterns formed by defining the coordinates in this vast plane are different from each other. That is, in the present exemplary embodiment, optical film 211 is used by cutting a small partial plane of the vast plane in which the dot patterns are defined.

Information related to a position coordinate of each unit area 213 is added to each dot pattern of optical film 211. That is, when optical film 211 is divided into unit areas 213 of 6 dots×6 dots, each dot pattern represents position coordinates of each unit area 213. In FIG. 4B, a dot pattern in area 213a represents position coordinates of a center position of area 213a, and a dot pattern of area 213b represents position coordinates of a center position of area 213b. When a tip of stylus diagonally moves to a lower right portion in FIG. 4B, area 213 read by digital pen 300 changes from area 213a to area 213b. That is, digital pen 300 reads the position coordinates of the center position of the dot pattern of area 213b from the position coordinates of the center position of the dot pattern of area 213a. A known method can be used for a method for patterning dot patterns (coding) and converting coordinates of the dot patterns (decoding) as described above.

### [4. Displaying Operation in the Case Where A Plurality of Display Devices Are Close]

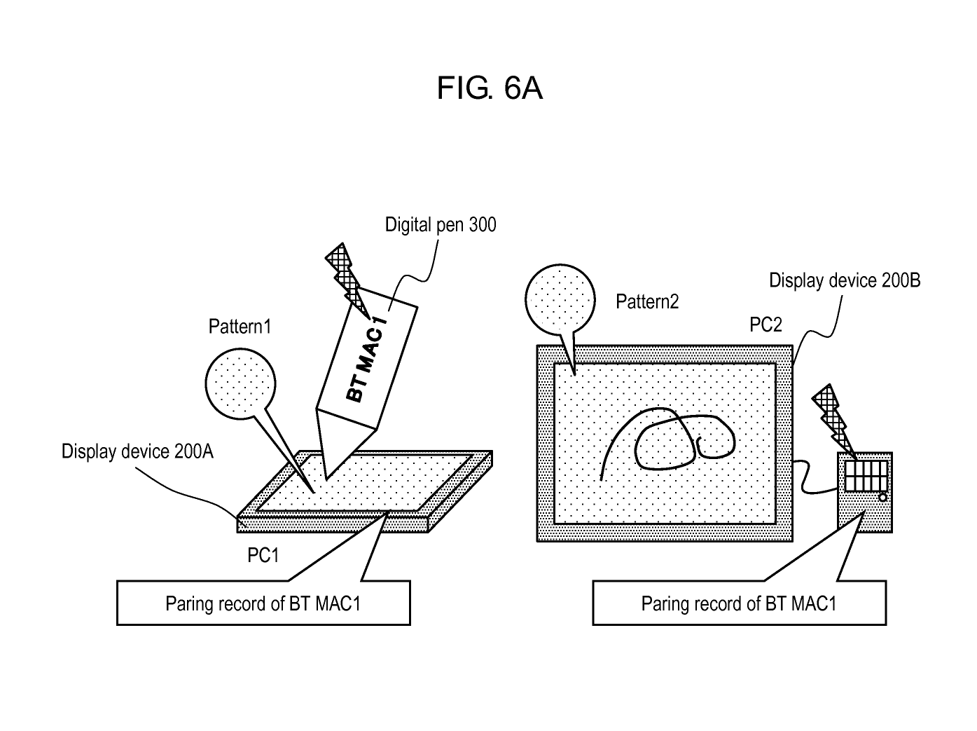

FIGS. 6A and 6B are image views illustrating displaying operations in a case where a plurality of display devices to be a communication target of digital pen 300 are close.

FIGS. 6A and 6B illustrate that tablet display device 200A and monitor display device 200B as display devices 200 to be a communication target of digital pen 300 are close. Display device 200A and display device 200B each include a display panel formed by optical film 211 on which the above dot pattern is formed. Further, display device 200A and display device 200B can each wirelessly communicate with digital pen 300 by, for example, a Bluetooth (registered trademark) technique. In addition, A will be assigned to tails of reference numerals of components of display device 200A. Similarly, B will be assigned to tails of reference numerals of components of display device 200B.

Digital pen 300 transmits a MAC address to a Bluetooth (registered trademark) device in a communicable range on a regular basis (digital pen 300 is in a discoverable mode described below). Display device 200A and display device 200B search for MAC addresses of Bluetooth (registered trademark) devices in a communicable range on a regular basis (display device 200A and display device 200B are in a search mode described below). In this case, digital pen 300 establishes wireless communication connection with one of display device 200A and display device 200B which is discovered earlier. Hence, digital pen 300 establishes wireless communication connection with one of display device 200A and display device 200B.

In this case, as illustrated in FIG. 6A, a phenomenon that, even though the user tries to operate display device 200A by using digital pen 300, digital pen 300 establishes wireless communication connection with display device 200B, and operation contents of display device 200A are displayed on the display panel of display device 200B may occur. This phenomenon makes it impossible to appropriately reflect operation contents in a target display device which the user intends to operate.

The inventors of the present invention have recognized the problem of the present invention and invented the solution in a process of a trial and an error in a case where a plurality of display devices 200 to be a communication target of digital pen 300 are close. According to this solution, as illustrated in FIG. 6B, when the user tries to operate display device 200 by using digital pen 300, it is possible to establish wireless communication connection between digital pen 300 and display device 200A, and appropriately reflect operation contents of display device 200A on the display panel of display device 200A. Consequently, even when a plurality of display devices 200 which are close to each other are used in parallel by using one digital pen 300, it is possible to appropriately reflect operation contents in display device 200 which the user intends to operate. The solution will be described in detail below.

### [4-1. Allocation of Position Coordinate Pattern to A Plurality of Display Devices]

It is assumed that coordinates of a partial range such as coordinates of a range of 123 km×123 km among the above coordinates of the vast plane of 60 million km×60 million km is allocated to the manufacturer of display device 200. The manufacturer of display device 200 divides a given plane of 123 km×123 km into ranges of 3 m×3 m (referred to as “divided regions” below). Further, in the display control system according to the present disclosure, the manufacturer of display device 200 forms position coordinate patterns of divided regions of coordinates different between individual display surfaces of a plurality of display devices to be manufactured. That is, position coordinate patterns of divided regions of the ranges of 3 m×3 m of different coordinates are formed for display device 200A and display device 200B. That is, one divided region corresponds to one display device. Hence, all display devices formed by using the plane of 123 km×123 km include different position coordinate patterns. Consequently, it is possible to specify a display device by reading a position coordinate pattern of a divided region. One of features of digital pen 300 according to the present disclosure includes performing control to establish wireless connection with a display device having a specific MAC address based on a read position coordinate pattern. This feature will be described.

In the display control system according to the present disclosure, digital pen 300 includes a plurality of MAC addresses, and manages a plurality of MAC addresses by using a correspondence table (described below). In this regard, the correspondence table is stored in pen-side memory 390, and a plurality of MAC addresses and coordinates indicating a position coordinate pattern range are associated with each other in the correspondence table. Digital pen 300 selects one of MAC addresses to use according to a position coordinate pattern read from display device 200. That is, digital pen 300 associates a position coordinate pattern of each divided region with a MAC address which is a unique ID of digital pen 300 associated with each display device 200 on a one-to-one basis. Thus, it is possible to integrally manage a position coordinate pattern formed on the display panel of display device 200 and a unique ID of this display device 200.

Pen-side microcomputer (controller) 360 identifies which display device 200 reading target display device 200 is by cross-checking coordinates indicating the read position coordinate pattern range and the following correspondence table stored in pen-side memory 390. That is, pen-side microcomputer 360 selects one MAC address of a plurality of MAC addresses based on the obtained position coordinate pattern, and controls transmitter 370 to establish wireless connection with a display device corresponding to the selected MAC address.

Table 1 indicates a correspondence table of MAC addresses stored in pen-side memory 390. In this correspondence table, coordinates (an X coordinate and a Y coordinate) indicating a position coordinate pattern range of each divided region, and a MAC address associated with this position coordinate pattern range are written. In this regard, a MAC address is used to establish wireless communication connection between digital pen 300 and predetermined display device 200.

TABLE 1

| MAC ADDRESS | COORDINATE X | COORDINATE Y |
|---|---|---|
| MAC ADDRESS A | 0~9999 | 0~9999 |
| MAC ADDRESS B | 10000~19999 | 0~9999 |
| MAC ADDRESS C | 20000~29999 | 0~9999 |
| . . . | | |

When the position coordinate pattern read from display device 200 by digital pen 300 indicates the coordinate X (10000 to 19999) and the coordinate Y (0 to 9999), pen-side microcomputer 360 determines to use MAC address B. Further, pen-side microcomputer 360 controls transmitter 370 to establish wireless communication with display device 200 associated with MAC address B by using determined MAC address B.

Consequently, digital pen 300 which has read the position coordinate pattern formed on the display panel of display device 200 can accurately determine with which display device of a plurality of display devices 200 which are close to each other wireless communication connection needs to be established.

### [4-2. Operation of Pairing Digital Pen 300 and Display Device 200]

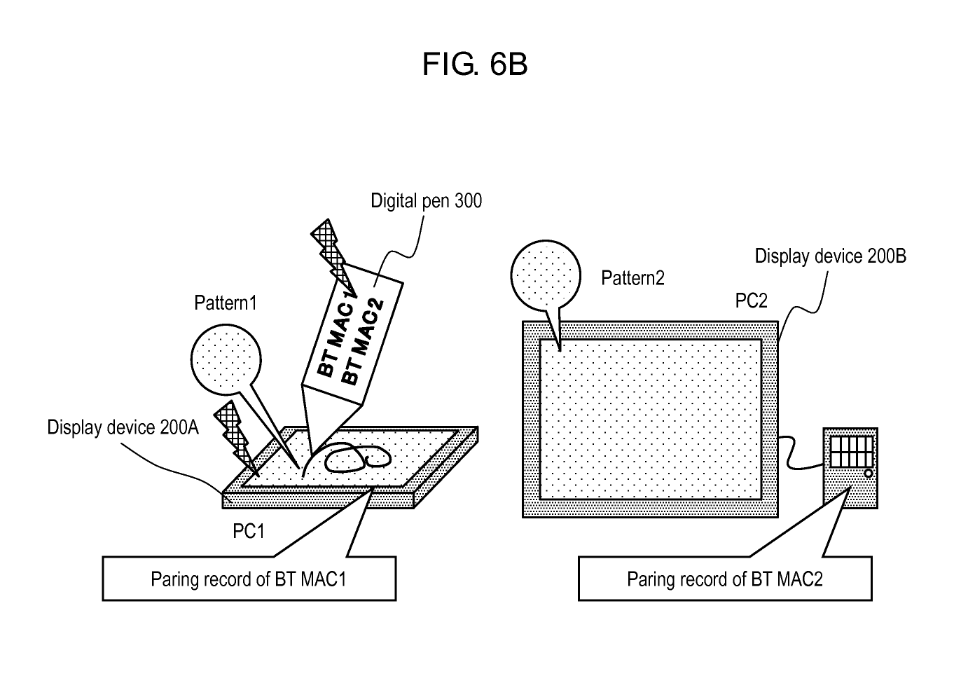

Next, the operation of pairing digital pen 300 configured as described above and display device 200 (an operation of authenticating each other when wireless communication connection is established for the first time) will be described with reference to FIG. 7. In this regard, the pairing operation is to connect Bluetooth (registered trademark) devices which perform Bluetooth (registered trademark) communication. According to Bluetooth (registered trademark), communication is performed by using radio waves. Therefore, this operation is a process of determining with which one of communicable Bluetooth (registered trademark) devices connection is established so as not to perform wireless communication with nearby irrelevant Bluetooth (registered trademark) devices. The pairing operation includes searching for Bluetooth (registered trademark) devices which exist in a range which radio waves reach, selecting a party with which connection needs to be established, inputting a same pin code to each other and authenticating each other. The devices which have been paired once are automatically connected from the next time. FIG. 7 is a flowchart illustrating a flow of the operation of pairing digital pen 300 and display device 200.

The operation of pairing display device 200A of a plurality of display devices 200A and 200B which are close to each other, and digital pen 300 will be described below. In addition, display device 200A and digital pen 300 employ the configuration illustrated in FIG. 2.

First, display device 200A which configures display control system 100, and digital pen 300 are powered on. Thus, display-side microcomputer 240 receives a supply of power from a power source which is not illustrated, and finishes an initial operation for executing various operations. Similarly, pen-side microcomputer 360 receives a supply of power from a power source which is not illustrated, and finishes an initial operation for executing various operations.

Next, the user performs an operation of starting pairing digital pen 300 and display device 200A. A known method only needs to be used for this operation. Thus, digital pen 300 and display device 200A enter a pairing standby state. That is, digital pen 300 enters a discoverable mode of transmitting the MAC address of digital pen 300 to Bluetooth (registered trademark) devices in a communicable range on a regular basis. Meanwhile, display device 200A enters a search mode of searching for MAC addresses of the Bluetooth (registered trademark) devices in the communicable range on a regular basis.

Next, digital pen 300 optically reads a position coordinate pattern formed on the display surface of display device 200A. In this case, pen-side microcomputer 360 specifies coordinates indicating the read position coordinate pattern (dot pattern) range (S500). Pen-side microcomputer 360 specifies the MAC address of digital pen 300 associated with reading target display device 200A (such a MAC address will be referred to as MAC address A below) by cross-checking the coordinates indicating the read position coordinate pattern range and the correspondence table stored in pen-side memory 390 (S510). Further, pen-side microcomputer 360 stores specified MAC address A in pen-side memory 390 (S520).

Pen-side microcomputer 360 starts wireless communication connection with display device 200A based on specified MAC address A. When display device 200A enters a communicable state, pen-side microcomputer 360 transmits MAC address A to receiver 230 of display device 200A. Display-side microcomputer 240 stores the MAC address of digital pen 300 received by receiver 230, in display device-side memory 250. Further, digital pen 300 and display device 200A establish wireless communication connection with each other (S530). Then, transmission of information from transmitter 370 of digital pen 300 to receiver 230 of display device 200A based on the read position coordinate pattern becomes possible.

A case where digital pen 300 performs an operation of paring with display device 200A has been described above. However, when digital pen 300 performs the operation of pairing with display device 200B, pen-side microcomputer 360 of digital pen 300 stores the MAC address of digital pen 300 associated with display device 200B (such a MAC address will be referred to as MAC address B below), in pen-side memory 390. Meanwhile, display device 200B stores the MAC address of digital pen 300 in display device-side memory 250. As a result, digital pen 300 and display device 200B establish wireless communication connection with each other.

Next, a reconnecting operation (an operation of authenticating digital pen 300 and display device 200A when wireless communication connection is established again) when the pairing operation is performed according to the above process, i.e., when there is a pairing history of digital pen 300 and display device 200A will be described. In this case, according to the above pairing operation, pen-side memory 390 stores MAC address A of digital pen 300 associated with display device 200A. Similarly, display device-side memory 250A of display device 200A stores MAC address A of digital pen 300 associated with display device 200A.

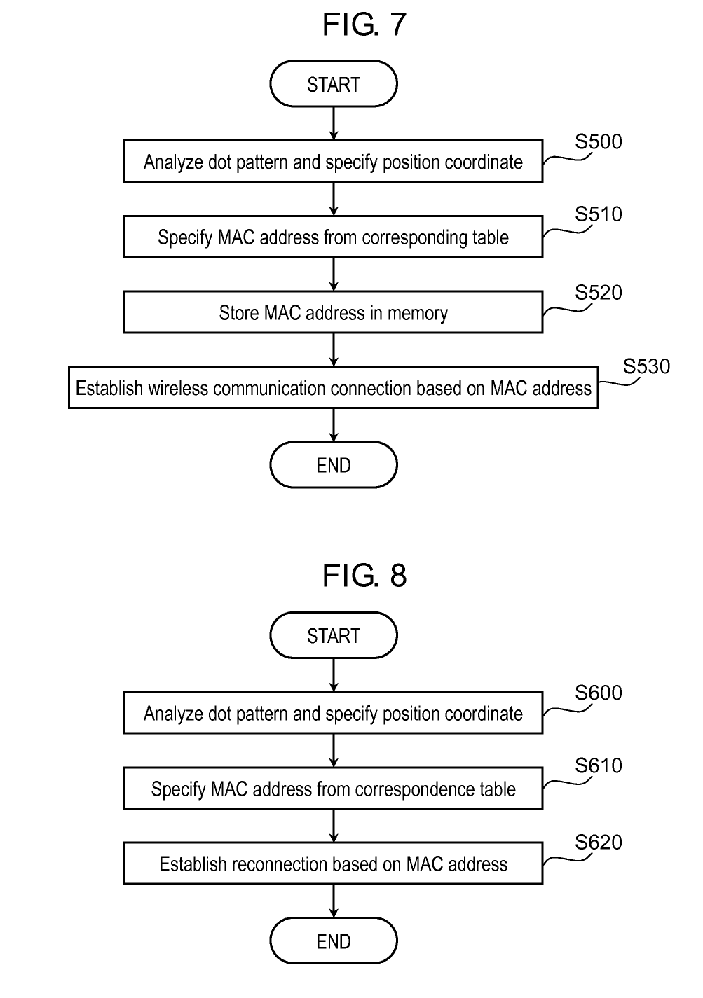

FIG. 8 is a flowchart for explaining an operation of reconnecting digital pen 300 and display device 200A. In FIG. 8, first, digital pen 300 optically reads a position coordinate pattern formed on the display surface of display device 200A. In this case, pen-side microcomputer 360 specifies coordinates indicating the read position coordinate pattern (dot pattern) range (S600). Pen-side microcomputer 360 specifies the MAC address of digital pen 300 associated with reading target display device 200A by cross-checking the coordinates indicating the read position coordinate pattern and the correspondence table stored in pen-side memory 390 (S610). Digital pen 300 transmits a MAC address of digital pen 300 to

Bluetooth (registered trademark) devices in a communicable range on a regular basis (discoverable mode). Meanwhile, display devices 200A and 200B search for MAC addresses of Bluetooth (registered trademark) devices in a communicable range on a regular basis (search mode). Further, when a MAC address A of digital pen 300 is stored in memories of communication connection target candidate devices, the known technique performs a communication reconnecting operation to establish wireless communication between the device and digital pen 300 (S620).

In this case, display device 200B has no pairing history with digital pen 300 having communication settings of MAC address A. Therefore, digital pen 300 can avoid erroneous connection with display device 200B.

### [4-3. Displaying Operation With Respect To Display Device 200 Using Digital Pen 300]

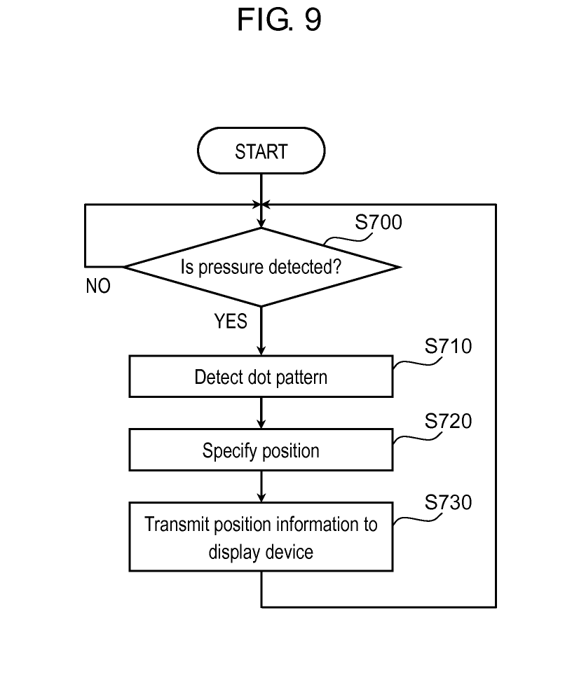

Next, a displaying operation of display control system 100 configured as described above will be described. FIG. 9 is a flowchart illustrating a flow of a displaying operation. A case where the user inputs (writes) characters in display device 200 by using digital pen 300 will be described below.

First, display device 200 which configures display control system 100, and digital pen 300 are powered on. Thus, display-side microcomputer 240 receives a supply of power from a power source which is not illustrated, and finishes an initial operation for executing various operations. Similarly, pen-side microcomputer 360 receives a supply of power from a power source which is not illustrated, and finishes an initial operation for executing various operations. Display device 200 and digital pen 300 establish wireless communication with each other by using the above pairing method. Thus, transmitter 370 of digital pen 300 can communicate with receiver 230 of display device 200.

Next, pen-side microcomputer 360 of digital pen 300 starts monitoring a pressure which works on tip of stylus 320 (S700). Pressure sensor 330 detects this pressure. When pressure sensor 330 detects a pressure equal to or more than the predetermined pressure (Yes in S700), pen-side microcomputer 360 determines that the user inputs characters in display panel 210 of display device 200 by the pen, and causes illuminator 380 to start irradiation.

Next, a component including objective lens 340 and image sensor 350 detects a dot pattern which is at a tip of stylus position and is formed on display panel 210 (S710).

In this regard, infrared light applied from illuminator 380 is diffused and reflected by liquid crystal panel 219, and part of the infrared light returns to digital pen 300. The infrared light returning to digital pen 300 side hardly transmits through dots 212 of the dot pattern. The infrared light having transmitted through regions between dots 212 reaches objective lens 340. Further, the infrared light is received by image sensor 350 through objective lens 212. Objective lens 340 is arranged to receive reflected light from a position pointed by tip of stylus 320 on display panel 210. As a result, a dot pattern of the position pointed by tip of stylus 320 on the display surface of display panel 210 is captured by image sensor 350.

Thus, the component including objective lens 340 and image sensor 350 optically reads the dot pattern. An image signal captured and generated by image sensor 350 is transmitted to pen-side microcomputer 360.

First, while pressure sensor 330 does not detect the pressure (while No continues in S700), pen-side microcomputer 360 repeats step S700.

Next, pen-side microcomputer 360 obtains a pattern shape of a dot pattern from the received image signal, and specifies the position of the tip of stylus on display panel 210 based on this pattern shape (S720). More specifically, pen-side microcomputer 60 obtains the pattern shape of the dot pattern by performing predetermined image processing on the obtained image signal. Next, pen-side microcomputer 360 finds unit area 213 (a unit area of 6 dots×6 dots) from an alignment of dots 212 in the obtained pattern shape, and specifies position coordinates (position information) of this unit area 213 from the dot pattern of unit area 213. Pen-side microcomputer 360 converts the dot pattern into position coordinates by performing a predetermined arithmetic operation corresponding to the dot pattern coding method.

Further, pen-side microcomputer 360 transmits the specified position information to display device 200 through transmitter 370 (S730). Thus, display device 200 can learn a tip of stylus position of digital pen 300.

The position information transmitted from digital pen 300 is received by receiver 230 of display device 200. The received position information is transmitted from receiver 230 to display-side microcomputer 240.

Display-side microcomputer 240 executes a displaying operation with respect to the display surface of display panel 210 when receiving the position information. More specifically, display-side microcomputer 240 controls display panel 210 to change display contents of a position corresponding to the position information in the display region of display panel 210. In this example, characters are input, and therefore dots are displayed at positions corresponding to position information in the display region of display panel 210. When a pen input of digital pen 300 continues, display-side microcomputer 240 continuously obtains position information. Thus, it is possible to continuously display dots at the position of tip of stylus 320 in the display region of display panel 210 following movement of tip of stylus 320 of digital pen 300. That is, a character corresponding to a stroke of tip of stylus 320 of digital pen 300 is displayed on display panel 210.

In addition, a case where characters are input on the display surface has been described above. However, how to use display control system 100 is not limited to this. What is input is not limited to characters (numbers), and symbols and figures can be naturally described. It is also possible to erase a character or a figure displayed on display panel 210 by using digital pen 300 like an eraser. Further, it is also possible to move a cursor displayed on display panel 210 or select an icon displayed on display panel 210 by using digital pen 300 like a mouse. That is, it is possible to operate a graphic user interface (GUI) by using digital pen 300.

### [5. Effect and Others]

As described above, digital pen 300 according to the present exemplary embodiment is a reading device which can communicate with and connect to one display device 200A of display devices 200A and 200B which each include a position dot pattern representing information related to a position, and which include transmitter 370 which communicates with and connects to display devices 200A and 200B, pen-side memory 390 which stores a plurality of MAC addresses A and B corresponding to display devices 200A and 200B, image sensor 350 which obtains the dot pattern, and a controller which selects one MAC address of a plurality of MAC addresses A and B based on the obtained dot pattern, and controls transmitter 370 to establish wireless connection with display device 200A associated with selected MAC address A.

Consequently, it is possible to read the dot pattern of display device 200A and reliably transmit the dot pattern to display device 200A associated with the read dot pattern. Hence, it is possible to prevent erroneous transmission of a dot pattern to display device 200B other than display device 200A associated with the reading target display surface. Hence, it is possible to adequately transmit the dot pattern to display device 200A associated with the reading target display surface.

Further, transmitter 370 transmits information related to the position corresponding to the obtained dot pattern, to display device 200A.

Thus, display device 200A can learn position information indicating a tip of stylus position of digital pen 300, and performs various types of display control.

Further, image sensor 350 optically reads a dot pattern.

Consequently, it is possible to accurately detect information related to the position at which the point of digital pen 300 is positioned on display panel 210.

Further, pen-side memory 390 stores the correspondence table in which dot pattern ranges and a plurality of MAC addresses are associated with each other.

Consequently, digital pen 300 can associate the read dot pattern with display device 200A on a one-to-one basis.

Further, the dot pattern is formed as a pattern of dots included in a unit area of 6 dots×6 dots.

The first exemplary embodiment has been described above as an exemplary technique disclosed in this application. However, the technique according to the present disclosure is not limited to this, and is also applicable to exemplary embodiments for which changes, replacements, addition and omission are optionally made.

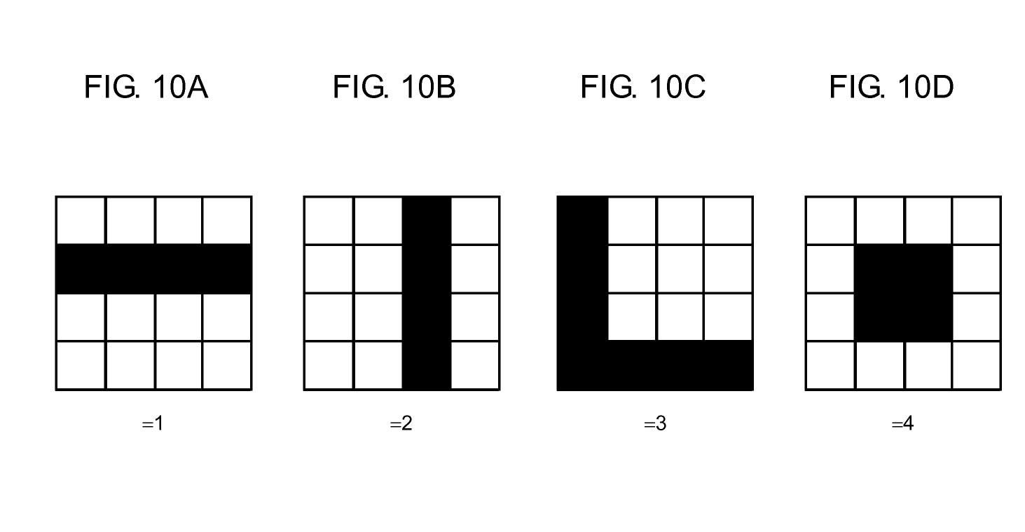

For example, a case where a position information pattern is a dot pattern has been illustrated above. However, the position information pattern is not limited to this. Instead of dots, predetermined marks may be regularly aligned to form a position information pattern. Alternatively, pixel block patterns illustrated in FIGS. 10A to 10D may form a position information pattern. In this case, pixel block patterns only need to be defined on optical film 211 to allow digital pen 300 to identify the pixel blocks as different pieces of information as in FIGS. 10A to 10D. In this regard, as illustrated in FIGS. 10A to 10D, only predetermined blocks of 4 pixel blocks×4 pixel blocks are painted black to form patterns corresponding to numerical values of “1” to “4”. More specifically, in the pattern in FIG. 10A, all pixel blocks in a second row from the top are painted black. This pattern corresponds to a value of “1”. In the pattern in FIG. 10B, all pixel blocks in a third column from the left are painted black. This pattern corresponds to a value of “2”. In the pattern in FIG. 10C, all pixel blocks in the first column from the left and in the first row from the bottom are painted black to form an “L” shape. This pattern corresponds to a value of “3”. In the pattern in FIG. 10D, all pixel blocks in a center are painted black. This pattern corresponds to a value of “4”. As described above, these patterns are read as numerical values of “1” to “4” by digital pen 300 according to these patterns. Even in this case, by, for example, forming one unit area of 6 pixel blocks×6 pixel blocks, it is possible to form an enormous number of pixel block patterns having different pieces of information.

Further, by using part of the vast plane defined as coordinates of pixel block patterns, all pixel block patterns (pixel block patterns in unit areas) are different patterns on optical film 211. Consequently, even when pixel block patterns are used to form position information patterns, it is possible to apply the invention according to the present disclosure, and prevent erroneous transmission of a position information pattern with respect to a display device other than a display device associated with a reading target display surface. Hence, it is possible to adequately transmit the position information pattern to display device associated with the reading target display surface. In the first exemplary embodiment, a case where whether or not to enable wireless communication connection is determined according to whether or not there is a MAC address of digital pen 300 associated with display device 200 has been described. However, the present disclosure is not limited to this. That is, whether or not to enable wireless communication connection may be determined according to coordinates indicating a position coordinate pattern range read from display device 200 by digital pen 300. In this case, pen-side memory 390 does not need to manage a plurality of MAC addresses. That is, there needs to be only one MAC address of digital pen 300. Further, display device-side memory 250 stores the correspondence table in which position coordinates indicated by position coordinate patterns and display devices 200 associated with the position coordinates are associated with each other. Further, display device-side microcomputer 240 performs cross-checking using the correspondence table based on the coordinate information received from digital pen 300. Display device-side microcomputer 240 cuts wireless communication when a cross-check result does not match with display device 200. Further, after cutting the wireless communication, display device-side microcomputer 240 performs control so as not to start a wireless communication connecting operation in a predetermined period. In this predetermined period, too, a display device which is a correct communication party searches for MAC addresses of Bluetooth (registered trademark) devices in a communicable range on a regular basis. Further, communication connection is established while communication with a display device which is a wrong communication party is cut. Thus, digital pen 300 can determine whether or not to enable wireless communication connection according to coordinates indicated by a position coordinate pattern read from display device 200.

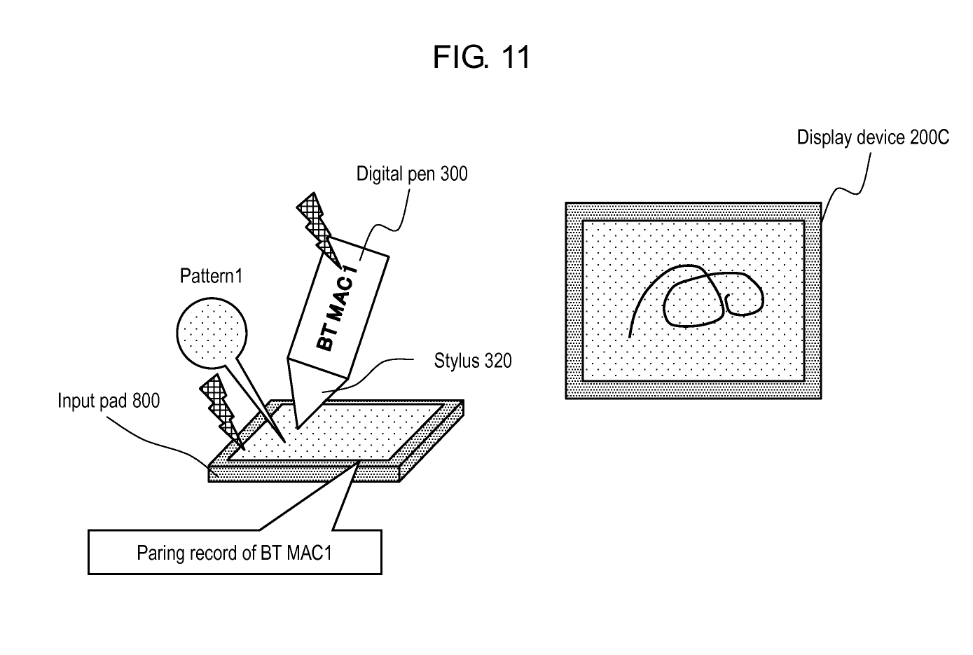

Further, in the above first exemplary embodiment, a case where a device which performs wireless communication with digital pen 300 is display device 200 has been described. The present disclosure is not limited to this. For example, as illustrated in FIG. 11, a device which performs wireless communication with digital pen 300 may be, for example, an input device such as capacitance input pad 800. Similar to the above first exemplary embodiment, in this case, too, digital pen 300 establishes wireless communication between digital pen 300 and input pad 800 by reading a position coordinate pattern of input pad 800. Next, when characters are input on input pad 800 by digital pen 300 by using the known technique, display device 200C which has received image information input by the pen displays image information on a display. That is, a character corresponding to a stroke of tip of stylus 320 of digital pen 300 is displayed on display device 200C.

Further, MAC addresses are used to identify a plurality of devices in the above first exemplary embodiment. The present disclosure is not limited to this. For example, other unique information which makes it possible to identify a plurality of devices may be used. In this case, too, it is possible to obtain the same operation and effect as the operation and the effect in the above first exemplary embodiment.

Therefore, components illustrated in the accompanying drawings and described in the exemplary embodiment include not only components which are indispensable to solve the problem but also components which are not indispensable to solve the problem to illustrate the above technique. Hence, it should not be immediately acknowledged that that the components which are not indispensable are illustrated in the accompanying drawings and described in the exemplary embodiment means that those components which are not indispensable are indispensable.

Further, the above exemplary embodiments are exemplary embodiments to illustrate the technique according to the present disclosure, and therefore various changes, replacement, addition and omission can be made in the claims or in a range equivalent to the claims.

The reading device according to the present disclosure relates to a reading device which can configure a display control system together with a plurality of display devices.

What is claimed is:

1. A reading device which can communicate with and connect to one of a plurality of devices which each include a position coordinate pattern representing information related to a position, the reading device comprising:
a communicator which communicates with and connects to a plurality of devices;
a memory which stores a plurality of pieces of unique information associated with the plurality of devices, respectively;
a pattern obtaining unit which obtains the position coordinate pattern; and
a controller which selects one of the plurality of pieces of unique information based on the obtained position coordinate pattern, and controls the communicator to establish wireless connection with a device associated with the selected unique information.

2. The reading device according to claim 1, wherein the communicator transmits information related to a position corresponding to the obtained position coordinate pattern, to the selected device.

3. The reading device according to claim 1, wherein the pattern obtaining unit optically reads the position coordinate pattern.

4. The reading device according to claim 1, wherein the memory stores a table in which a range of the position coordinate pattern is associated with the plurality of pieces of unique information.

5. The reading device according to claim 1, wherein the position coordinate pattern is a dot pattern.

6. The reading device according to claim 5, wherein the dot pattern is formed of a dot pattern of which unit area contains 6 dots×6 dots.

7. The reading device according to claim 1, wherein the plurality of pieces of the unique information each include a MAC address.

8. The reading device according to claim 1, wherein the plurality of devices includes at least one of a display device including a display surface which displays an image, and a capacitance input pad.
